(19) United States
(12) Patent Application Publication
(10) Pub. No.: US 2006/0253511 A1
(43) Pub. Date: Nov. 9, 2006

(54) RF broadcasting employing sinusoidal-cosine wave generation with plural look-up tables

(75) Inventors: Carlos Garcia Abascal, Middletown, OH (US); Anders S. Mattsson, Mason, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Harris Corporation

(21) Appl. No.: 11/123,990

(22) Filed: May 6, 2005

(51) Int. Cl. G06F 1/02

(52) U.S. Cl. 708/270

(57) ABSTRACT

An RF broadcasting system is presented that employs sinusoidal wave generation with look-up tables. The system includes a base band signal generator that converts a received N bit digital base band signal into an N bit digital address based on the base band signal. A signal processor is included having a plurality of addressable look-up tables that provide sinusoidal wave generating data, each of the tables receiving the address and providing therefrom multi-bit wave generating data. The processor also includes multipliers and summer means all configured and arranged to perform the algorithm:
Cos [a+b]=Cos [a]·Cos [b]−Sin [a]·Sin [b] or the algorithm:
Sin [a+b]=Cos [b]·Sin [a]+Cos [a]·Sin [b] for use in the generation.

### BACKGROUND OF THE INVENTION

1. Technical Field

This invention relates to the art of RF broadcasting and, more particularly, to sinusoidal-cosine wave generation employing look-up tables.

2. Description of the Prior Art

In the field of RF broadcasting, the use of sine wave generation is employed in creating various signals including carrier waves. In this area of communications, the need for sine wave generators has found use in generation of a carrier that is modulated in amplitude by input audio and amplitude modulation or AM. Also, in analog television (TV) sine-wave generation is used for several of the signal subcarriers. Also, sine wave generation is employed in the generation of a composite signal for stereo FM and the carrier that is frequency modulated. Additionally, such sine wave generation is employed in the process of spectrum translation of a signal from one frequency band to another, a very common process in communications where is also known as mixing.

There is ample knowledge of the method and devices used for generation of a sine wave by using analog electronic hardware. In modern communication equipment though, more and more of the functions that were usually performed by analog circuitry are now being performed by programmable digital devices. This process is known as Digital Signal Processing or DSP and entitles, among other things, the conversion of the signals in question into sequences of numbers that represent the instantaneous values of a signal at fixed intervals of time. All the processing that used to be performed to the signal by analog electronic devices like filtering, mixing, modulation, etc., is now performed by the application of some mathematical rules to these sequences. It is a well-recognized fact that the vast advances in telecommunications during the last decade are due to a great extent to the development in the area of DSP.

Implementing a high-speed sine wave synthesizer pushes the limits of current DSP technology. The problem arises because the standard algorithms used to calculate any trigonometric function in a programmable DSP are based on the Taylor series expansion of the function in question, which is a very time consuming procedure. Hence, for a given finite number of CPU cycles only a limited number of results can be rendered in real time. Several alternative algorithms have been developed specifically intended to boost the performance of sine wave generation. These often require some kind of trade-off between memory and computational complexity. For example, increasing the memory in a look-up table often reduces the computational requirements. The presently known methods for the generation of pure sinusoidal waves are:

1—Taylor series expansion

2—Direct look-up-table

3—Interpolated look-up-table

4—Recursive iteration.

5—Resonator

If the signal to be generated instead of being a pure sine wave of constant amplitude and frequency, has arbitrary phase at any point in time, like in the case of a modulated carrier on the FM broadcast transmission, only the first three of the above-mentioned methods can be used.

The present invention includes a new algorithm based on the use of multiple look-up-tables and a rotational matrix operator, that compares favorably with any of the known methods. It is much faster than the Taylor expansion algorithms, for instance one version is more than 20 times faster than the optimized version of the algorithm implemented in the Texas Instrument DSP, known as model number TMS320C6713 DSP. So, for a wide range of applications where performance is of paramount importance, the only viable choices are 2 and 3. Furthermore, since method 3 is an improvement of 2 regarding the precision of the calculations at the expense of extra mathematical operations only the comparison from method 3 has relevance.

### SUMMARY OF THE INVENTION

In accordance with the invention, an RF broadcasting system is presented that employs sinusoidal wave generation with look-up tables. The system includes a base band signal generator that converts a received N bit digital base band signal into an N bit digital address based on the base band signal. A signal processor is included having a plurality of addressable look-up tables that provide sinusoidal wave generating data, each of the tables receiving the address and providing therefrom multi-bit wave generating data. The processor also includes multipliers and summer means all configured and arranged to perform the algorithm:
Cos [a+b]=Cos [a]·Cos [b]·Sin [a]·Sin [b]
or the algorithm:
Sin [a+b]=Cos [b]·Sin [a]+Cos [a]·Sin [b]
for use in the generation.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic-block diagram of an FM transmitter employing the invention herein; and

FIG. 2 is a schematic-block diagram of one form of the invention herein.

### DESCRIPTION OF A PREFERRED EMBODIMENT

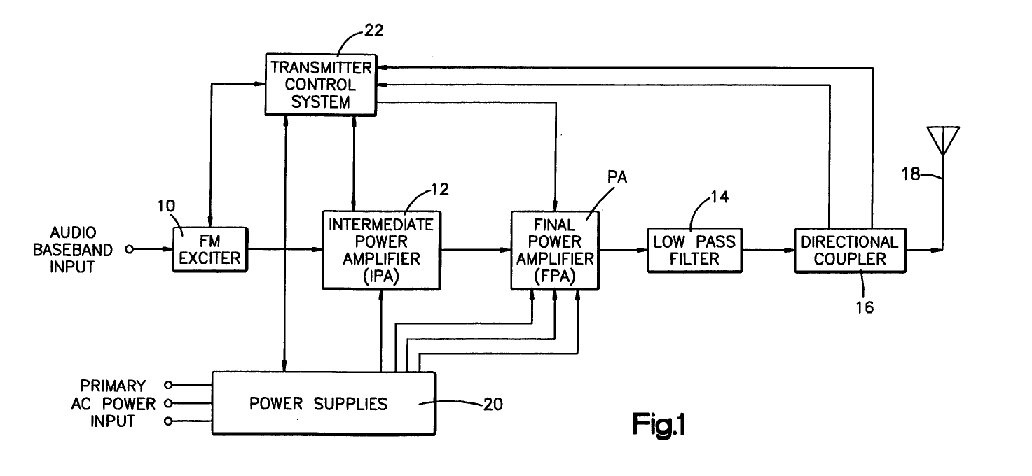

To more fully explain the invention herein, reference is now made to FIG. 1 which illustrates an FM transmitter. The purpose of such an FM transmitter as shown in FIG. 1, is to convert a main channel audio (mono or stereo) frequency signal and its associated audio or data subcarriers into a frequency modulated, radio frequency signal at the desired power output level to feed into a radiating antenna system. As shown in FIG. 1 the transmitter includes a plurality of subsystems including an FM exciter 10 that receives an analog audio baseband or serial digital audio data and converts this into a frequency modulated RF signal and determines the key qualities of the signal. The output of the FM exciter 10 is amplified by an intermediate power amplifier 12 to boost the RF power level up to a level sufficient to drive the final stage. The power amplifier supplies a final power amplifier PA which further increases the signal level to a final value required to drive the antenna system. A low pass filter 14 removes undesired harmonic frequencies from the transmitter's output, leaving only a fundamental output frequency. The signal supplied by the filter 14 is then applied to a directional coupler 16 that provides an indication of the power being delivered to and reflected from the antenna system including antenna 18. A power supply 20 converts power supplied by an AC line into the various DC or AC voltages and currents needed by the various subsystems of FIG. 1. A transmitter control system 22 monitors, protects and provides commands to each of the subsystems so that they work together to provide the desired result.

The point to presenting the discussion above relative to FIG. 1 is to show the atmosphere within which an FM exciter may be found. The present invention dealing with sinusoidal wave generation may be employed in an FM exciter as will be described below.

The heart of an FM broadcast transmitter is its exciter. The function of the exciter is to generate and modulate the carrier wave with one or more inputs (mono, stereo, SCA) in accordance with FCC standards. The FM modulated carrier is then amplified by a wideband amplifier to the level required by the transmitter's following stage.

Stereo transmission places the most stringent performance requirements upon the exciter. Since the exciter is the origin of the transmitter's signal, it determines most of the signal's technical characteristics including signal to noise ratio, distortion, amplitude response, phase response and frequency stability. Waveform linearity, amplitude bandwidth and phase linearity must be maintained within acceptable limits throughout the analog baseband chain from the stereo and subcarrier generators to the FM exciter's modulated oscillator. The introduction of AES3 digital audio transport and all digital FM modulation techniques like DDS eliminate the distortions introduced by analog circuits. In a fully digital FM exciter, the left and right audio data is converted into a digital representation of stereo baseband by DSP. This data is then further converted into a frequency modulated carrier by Direct Digital Synthesis (DDS) algorithm, also running in the DSP. Several Interpolation stages, a frequency translation (in a digital mixer), performed in an FPGA follow the DSP stage, which in turn renders the signal into a D/A converter at which point it has become a fully modulated analog FM signal at low power level. From here, the FM carrier is usually amplified in a series of power amplifiers. The amplitude and phase responses of all the RF networks which follow the exciter must also be controlled to minimize degradation of the signal quality.

The Direct Digital Synthesis (DDS) algorithm allows direct synthesis of the carrier frequency, including FM modulation, from a mathematically generated sinewave operating in conjunction with a digital phase accumulator. When this technique is embedded into a DSP in combination with the process of generation stereo baseband, the SCAs and FM modulating this baseband information onto the RF carrier, the entire modulation process takes place in the digital domain. The FM signal generated by this method has extremely low noise and distortion for true 16 bit digital audio quality.

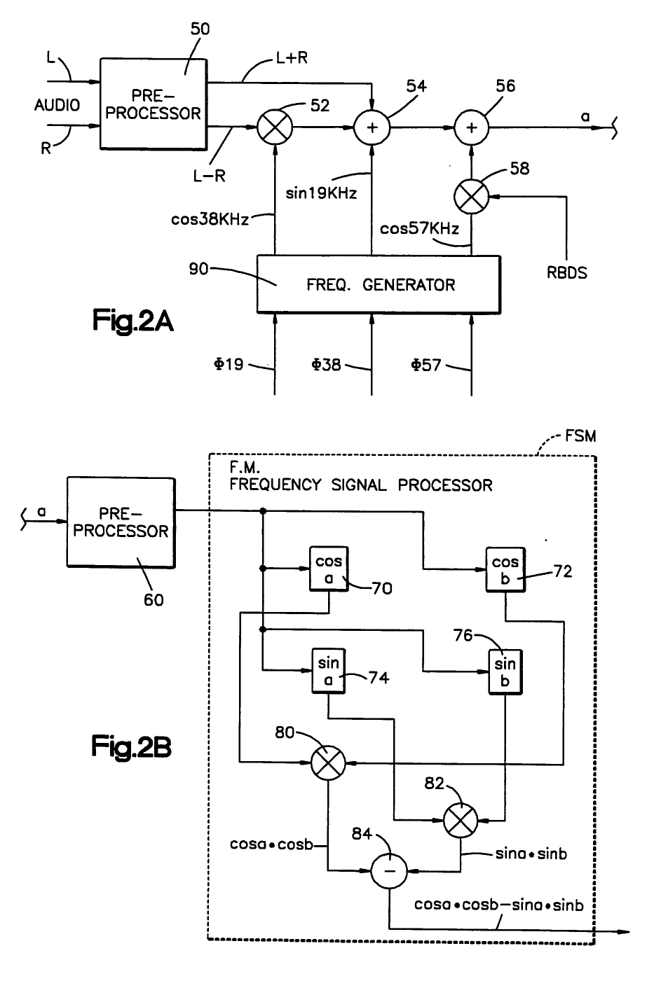

The implementation of the DDS in DSP uses a 32-bit Numerically Controlled Oscillator (NCO). It is perfectly possible to implement the NCO using a different number of bits. The choice of 32 bits depends of the particular requirements of the application where this disclosure is being use. Also note that the term NCO is used in this context as an alternate way of referring to the Frequency Signal Processor block of FIG. 2B. The basic resting frequency of the NCO is set by a 32 bit tuning word. Frequency modulation occurs when modulation data varies the structure of the tuning word within the phase accumulator section of the NCO. The modulated outputs of the NCO are a pair of orthogonal carriers modulated in frequency that represents the cosine and sine of the tuning word respectively, and that are conventionally known as I and Q components.

Since at the essence of this process lies the calculation in real time of the sine and cosine of the phase accumulator tuning word, it is imperative that this calculation be performed at very high speed and with high precision.

Reference is now made to FIG. 2 which illustrates a simplified block diagram of the generation of a composite signal used in stereo FM transmission in an exciter in accordance with the present invention. The left L and right R audio channels are supplied to a preprocessor 50 that provides sum and difference signals including L+R and L−R signals. The L−R audio signal modulates with a Cos [2πft] where f=38 kHz subcarrier at a mixer 52. The output of the mixer 52 is supplied to an adder 54 to which is added a 19 kHz signal and the L+R signal. The result is supplied to the adder 56 along with the output from the adder 54. The composite baseband signal is then supplied to a preprocessor 60 which supplies a phase signal, which serves as an address to a frequency signal processor FSM. This processor includes a plurality of look-up tables (LUT) to provide Cos [a] at LUT 70, and Cos [b] at LUT 72, Sin [a] at LUT 74 and Sin [b] at LUT 76. These look-up tables receive a phase input β represented as a 16 bits quantity from the preprocessor 60. This 16 bit word is split into the upper, most significant byte (comprising bits 8 to 15) and the lower or least significant byte (comprising bits 0 to 7). These bytes represent the coarse and fine parts of the particular input phase β, i.e., β=a+b. The upper byte, corresponding to the coarse portion of the phase a, is used to address the tables that store Cos [a] and Sin [a], while the lower byte, corresponding to the fine portion of the phase b is used to address the tables that store Cos [b] and Sin [b]. Since a byte represents 256 different addresses (ranging from 0 to 255) this sets the size of each of the LUTS to 256 locations. The content of each of LUT is described in detail in the following table:

| Address | LUT 70 | LUT 74 | LUT 72 | LUT 76 |
|---|---|---|---|---|
| 0 | Cos [0] | Sin [0] | Cos [0] | Sin [0] |
| 1 | Cos [2π/256] | Sin [2π/256] | Cos [2π/65536] | Sin [2π/65536] |
| 2 | Cos [4π/256] | Sin [4π/256] | Cos [4π/65536] | Sin [4π/65536] |
| k | Cos [k2π/256] | Sin | Cos | Sin |
| | | [k2π/256] | [k2π/65536] | [k2π/65536] |
| 255 | $Cos [ 2 π \frac{255}{256} ]$ | $Sin [ 2 π \frac{255}{256} ]$ | $Cos [ 2 π \frac{255}{65536} ]$ | $Sin [ 2 π \frac{255}{65536} ]$ |

Each of the LUT supplies its contents as a multi-bit output therefrom. These outputs are supplied to mixers 80 and 82 to obtain the product Cos [a]·Cos [b], and the product Sin [a]·Sin [b]. The outputs of the mixer 80 and 82 are supplied to a subtracter 84 which then provides the difference between the two signals, i.e., it provides the signal Cos [a]·Cos [b]−Sin [a]·Sin [b]=Cos [a+b]=Cos [β]. Alternatively, FIG. 2 may be revised to provide a summation of the a different set of products so as to render the result Cos [b]·Sin [a]+Cos [a]·Sin [b]=Sin [a+b]=Sin [β]

As previously indicated each of the look-up tables 70, 72, 74 and 76 may each store 256 samples of the sinusoidal signal to be generated. If a single look-up table was to be used to perform this function, then a digital 16 bit number would require 65,536 samples and this would require an impractical amount of storage space given the available technology. If instead 20 bits of phase precision were desired the required storage spaces would be 4096 for the multiple LUT case versus 1048576 for the single LUT case. In general if the phase were to be represented as an arbitrary N bit number, the trade off between this implementation and a single look-up table can be summarized as follows:

| | Required | Required number |
|---|---|---|
| | Mathematical | of Memory |
| | Operations per | Allocation units |
| | output value | for Storage |
| Single LUT | None | 4\sqrt{N} |
| Multiple LUT | 1 multiplication | N |
| | 1 addition | |

In order to achieve the information for generating such a sinusoidal signal with today's technology, the foregoing shows that it can be accomplished with four look-up tables such as tables 70, 72, 74 and 76 together with two multipliers such as mixers 80 and 82 along with an adder/subtracter device 84.

It is worth noticing at this point that since the algorithm in question is capable of calculating a sine/cosine for an arbitrary input phase, it can also be used (and in fact is used) for the particular calculations of all the constant frequency sine waves used throughout all the algorithms running in the DSP for the generation of the 19 kHz pilot, the 38 kHz stereo subcarrier, and the 57 kHz RBDS subcarrier. Consequently, the frequency generator 90 that supplies the 19 kHz signal, the 38 kHz signal and the 58 kHz signal may be comprised of look-up tables and multipliers and a subtracter such as that employed by the signal processor FSM.

Although the invention has been described with respect to a preferred embodiment, it is to be appreciated that various modifications may be made without departing from the spirit and scope of the invention as defined by the appended claims. Further reductions in the size of the LUT can be achieved by making use of the relation Cos [a]=Sin [a+π/2]. Also It is easy to extend on the basic concept by splitting the angle into three or more “groups” instead of two as described in this application. For instance if 0≦α≦β≦γ≦2π where α+β+γ are a phase value represented by an L+M+N bits digital number where the phase L, M and N are three groups of bits representing the most, the middle and least significant bits of the phase word associated with the phases α, β and γ. By iterative application of the trigonometric identities given earlier we arrive to the equation, Cos [α+β+γ]=Cos [α]·Cos [α]·Sin [γ]+Cos [α]·Cos [γ]·Sin [β]−Sin [α]·Sin [β]·Sin [γ] which could in turn be implemented by means of the use of six LUT.

Having described the invention, we claim:

1. An RF broadcasting system employing sinusoidal wave generation with look-up tables and comprising:
a base band signal generator that converts a received N bit digital base band signal into an N bit digital address based on said base band signal;
a signal processor including a plurality of addressable look-up tables that provide sinusoidal wave generating data, each of said tables receiving said address and providing therefrom multi-bit wave generating data, said processor also including multipliers and summer means all configured and arranged to perform the algorithm:
Cos [a+b]=Cos [a]·Cos [b]−Sin [a]·Sin [b]
or the algorithm:
Sin [a+b]=Cos [b]·Sin [a]+Cos [a]·Sin [b]
for use in said generation.

2. A system as set forth in claim 1 wherein N is at least 16.

3. A system as set forth in claim 1 wherein said plurality of look-up tables includes four look-up tables each storing a plurality of wave generating sample data.

4. A system as set forth in claim 3 including two said multipliers.

5. A system as set forth in claim 4 wherein said summing means includes a summer-adder.

6. A system as set forth in claim 3 wherein N is equal to at least 16.

7. A system as set forth in claim 6 wherein each said look-up table stores 256 wave generating sample data.
